(19) United States
(12) Patent Application Publication
(10) Pub. No.: US 2025/0141025 A1
(43) Pub. Date: May 1, 2025

(54) End Plate Assembly for a Battery of an Electric Bicycle

(71) Applicant: Robert Bosch GmbH, Stuttgart (DE)

(72) Inventor: Joern Merwitz, Kusterdingen (DE)

(21) Appl. No.: 18/919,950

(22) Filed: Oct. 18, 2024

(30) Foreign Application Priority Data
Oct. 25, 2023 (DE) 10 2023 210 516.0

(51) Int. Cl. H01M 50/262; B62J 43/13; B62J 43/20; H01M 50/249

(52) U.S. Cl. CPC H01M 50/262; B62J 43/13; B62J 43/20; H01M 50/249; H01M 2220/20

(57) ABSTRACT

An end plate assembly for a battery of an electric bicycle includes (i) a battery case having a fastening interface, (ii) an end plate, and (iii) at least one fixing element. The fastening interface includes at least one protruding first fastening element. The end plate includes at least one second fastening element which can be engaged with the first fastening element of the fastening interface to produce a positive-locking connection. The end plate can be secured to the fastening interface by way of the fixing element.

This application claims priority under 35 U.S.C. § 119 to patent application no. DE 10 2023 210 516.0, filed on Oct. 25, 2023 in Germany, the disclosure of which is incorporated herein by reference in its entirety.

### BACKGROUND

The present disclosure relates to an end plate assembly for a battery of an electric bicycle, a battery assembly, and an electric bicycle.

Battery assemblies for electric bicycles are known in which the battery can be attached to the electric bicycle by way of battery holders in such a way that it can be removed again. Often, the battery holder is disposed on a bicycle frame of the electric bicycle. The batteries are often formed with an elongated, for example prismatic or substantially cylindrical geometry, and are for example held by the battery holder on both end faces. End plates are often provided, for example as adapters, between the battery and the battery holder. The end plates are typically screwed to the battery.

### SUMMARY

In contrast, the end plate assembly according to the disclosure with the features set forth below offers the advantage of a particularly simple and inexpensive construction, which allows a stable attachment to the battery with particularly compact geometry and lightweight construction. This is achieved by an end plate assembly for a battery of an electric bicycle comprising a battery case, an end plate, and at least one fixing element. The battery case comprises a fastening interface comprising at least one protruding first fastening element. The end plate comprises at least a second fastening element. The second fastening element can be hooked into the first fastening element of the fastening interface to form a positive-locking connection between the first fastening element and the second fastening element. In addition, the end plate can be secured to the fastening interface by way of the fixing element.

Preferably, the battery case is adapted to receive a battery provided as an electrical energy store for an electric bicycle.

In other words, an end plate assembly is provided comprising an end plate which is, for example, substantially plate-shaped and which can be fastened to the battery case. It is fastened on the one hand by way of the fastening elements and on the other by way of the fixing element. The fastening elements are configured such that the end plate can be hooked to the battery case in order to establish a positive-locking connection, for example along at least one predetermined direction in the hooked state between the battery case and the end plate. For example, an at least partial engagement of the first fastening element and the second fastening element can be considered to be hooking. Preferably, the first fastening element may engage the second fastening element, particularly such that the fastening elements at least partially undercut one another in the hooked state to form the positive-locking connection. In addition, the end plate is fixed by way of the fixing element. Preferably, it is fixed by the fixing element such that this fixing prevents unhooking, i.e., the release of the positive-locking connection.

The end plate assembly offers the advantage of making a stable and reliable attachment of the end plate to the battery case possible by way of a particularly simple and inexpensive and lightweight design. Fastening by way of the positive-locking connection produced by the fastening elements can provide a stable fastening in a simple manner which, for example, renders use of a larger number of screws unnecessary. That means, for example, that the end plate can be mounted to the battery housing in a particularly stable and reliable manner while using as few screws as possible. In addition, the design of the end plate and battery case allows for particularly space-saving geometry.

Preferred embodiments of the disclosure are also described below.

Preferably, the end plate assembly comprises exactly two first fastening elements and exactly two second fastening elements. This allows for a solid attachment with the most space-saving and material-saving design possible. In particular, two first and two second fastening elements can be used to easily prevent relative rotation of the end plate and battery case with respect to one other.

Preferably, the end plate assembly comprises exactly two fixing elements. Thus, a lightweight and inexpensive design can be provided for the end plate assembly, wherein a solid attachment is reliably provided, particularly by preventing relative movement of the end plate and battery case to one other.

Particularly preferably, the battery case extends along a longitudinal axis. Preferably, the battery case is designed to be prismatic, in particular substantially cylindrical. The fastening interface is arranged at a front end of the battery case. Preferably, the end plate assemblies on both end faces of the battery case may each comprise a fastening interface and an end plate.

Preferably, the end plate is arranged substantially orthogonal to the longitudinal axis when secured. In particular, the end plate has a substantially plate-like geometry that extends in a plane orthogonal to the longitudinal axis. Thus, a particularly compact geometry may be provided for the fully mounted end plate assembly.

Further preferably, the fastening elements are configured to permit hooking through a pivoting movement of the plate about a pivot axis which is arranged orthogonal to the longitudinal axis. In other words, the hooking may be provided in that the second fastening element may be caused to engage the first fastening element when the plate is inclined, for example, by a predetermined pivot angle, in particular at least 5°, with respect to the end face. Subsequently, when the first fastening element and the second fastening element are engaged with one other, the end plate may be pivoted about the longitudinal axis towards the fastening interface, in particular until the end plate is disposed substantially orthogonal to the longitudinal axis. The fixation can then preferably be carried out by way of the fixing element. Preferably, the fastening elements are configured and arranged such that the pivot axis is arranged at a radially outer edge of the fastening interface and end plate. Fastening the end plate by way of a pivoting movement is, thus, a particularly simple way to ensure that a reliable fixation is provided with the most compact geometry as possible for the end plate assembly.

Particularly preferably, the fixation of the end plate is carried out by way of the at least one fixing element, in particular exclusively, along a direction parallel to the longitudinal axis. That is to say, the end plate is held in an immobile manner on the fastening interface by way of the fixing element along the direction parallel to the longitudinal axis. By way of example, this can prevent a pivoting backward about the pivot axis in order to release the positive-locking connection generated by the fastening elements. Preferably, the fixing element may be configured to additionally prevent movement of the end plate in a direction orthogonal to the longitudinal axis.

Preferably, the first fastening element is formed as a protruding hook. For example, the hook may comprise a first area protruding parallel to the longitudinal axis and additionally comprise a second area protruding substantially orthogonal to the longitudinal axis from the end distant from the first area. In this way, a particularly simple design can be provided for the fastening elements which also allows for a robust attachment of the end plate.

Further preferably, the second fastening element is formed as a recess. For example, the recess may be formed in a tab-shaped, for example protruding, sub-area of the end plate. Thus, in particular, the first fastening element may be inserted into the recess and arranged such that the first fastening element and an area of the end plate undercut one another to form the positive-locking connection. In this way, a particularly robust attachment can be provided using a simple design.

Preferably, the fixing element is formed as a screw. In particular, the screw may be screwed into the fastening interface of the battery case through the end plate to secure the end plate to the fastening interface.

Particularly preferably, the first fastening element is disposed on a radially outer edge of the fastening interface. Alternatively or additionally preferably, the second fastening element is disposed on a radially outer edge of the end plate. In this way, it can be possible to produce the positive-locking connection in a particularly simple manner through hooking, and in particular the pivoting movement, with an end plate assembly manufactured in a simple and inexpensive way.

Further, the disclosure results in a battery assembly comprising a battery and the end plate assembly described. The battery is arranged within the battery case of the end plate assembly.

Further, the disclosure relates to an electric bicycle comprising the described battery assembly. Preferably, the battery assembly can be attached to a bicycle frame of the electric bicycle. Preferably, the electric bicycle comprises, in particular on the bicycle frame, at least one retaining element to which the end plate of the end plate assembly can be attached in such a manner that it can be removed again.

### BRIEF DESCRIPTION OF THE DRAWINGS

The disclosure is described hereinafter based an exemplary embodiment in connection with the figures. In the drawings, functionally identical components are respectively denoted by identical reference signs. Shown are:

FIG. 1 a simplified schematic view of an electric bicycle with an end plate assembly according to a preferred exemplary embodiment of the disclosure,

FIG. 2 a detailed view of the end plate assembly of FIG. 1 during mounting,

FIG. 3 a detailed view of the end plate assembly of FIG. 1 in the fully mounted state,

FIG. 4 a detail of the end plate assembly of FIG. 1, and

FIG. 5 a further detailed view of the end plate assembly of FIG. 1.

### DETAILED DESCRIPTION

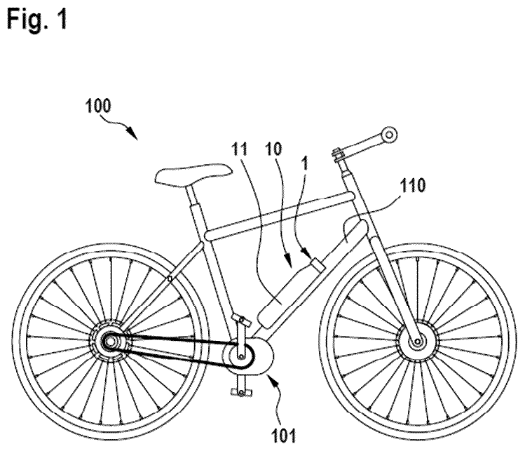

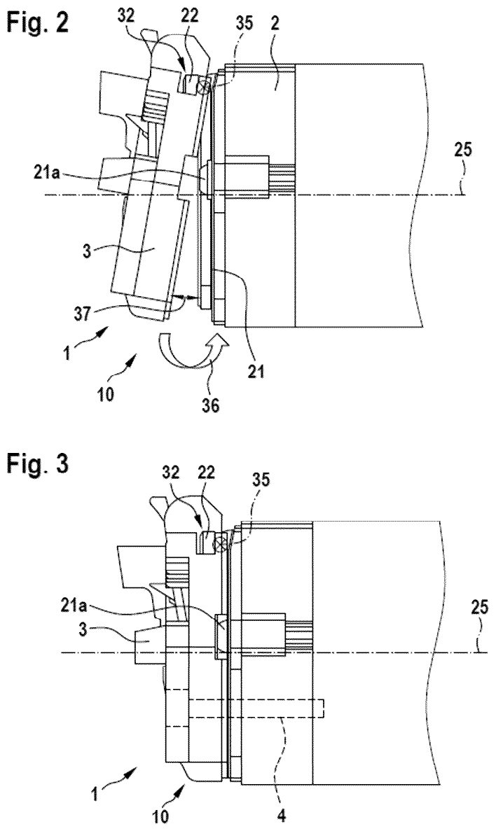

FIG. 1 shows a highly simplified schematic view of an electric bicycle 100 comprising an end plate assembly 1 according to a preferred exemplary embodiment of the disclosure. The end plate assembly 1 is part of a battery assembly 10, which additionally comprises a battery 1. Details of the end plate assembly 1 of the preferred exemplary embodiment are shown in FIGS. 2 to 5.

The battery 11 serves as an electrical energy store for supplying electrical energy to a drive unit 101 of the electric bicycle 100. The drive unit 101 makes it possible for a generated motor torque to provide electromotive support for the pedal force generated by the muscle power of a rider of the electric bicycle 100.

The battery 11 is elongated, for example substantially prismatic. The battery 11 can be attached to the electric bicycle 100 by way of the battery assembly 10 in such a manner that it can be removed again. For this purpose, the battery assembly 10 can be secured to a bicycle frame 110 of the electric bicycle 100.

The electric bicycle 100 includes (not shown in detail) retaining elements which are fixed to the bicycle frame 110, or which are an integral part of the bicycle frame 110, for example. The retaining elements can be used to attach the battery assembly 10 to the bicycle frame 110 in such a manner that it can be removed again.

The end plate assembly 1 comprises a battery case 2 within which the battery 11 is mounted. In particular, the battery case 2 is designed for mounting and protecting the battery 11. The battery case 2 extends in an elongated manner along a longitudinal axis 25.

The battery case 2 comprises a fastening interface 21, which is arranged on a front end of the battery case 2 (cf. FIG. 2).

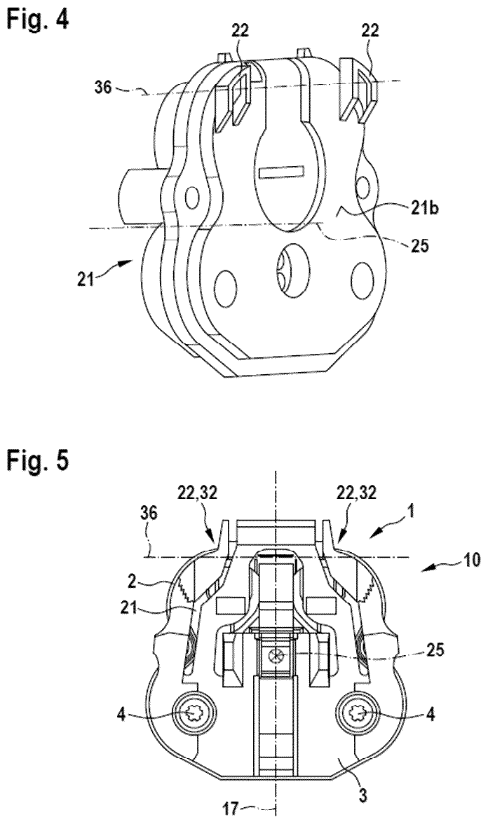

The fastening interface 21 is shown in a perspective detailed view in FIG. 4. For example, the fastening interface 21 can be configured as a separate component from the rest of the battery case 2, and preferably can be secured to the battery case 2 by way of screws 21a.

In addition, the end plate assembly 1 comprises an end plate 3, which is in particular substantially configured as a flat plate.

The end plate 3 is provided in particular as a mechanical connecting element between the battery case 2 and the retaining element. Alternatively or additionally preferably, the end plate 3 can be provided as an adapter between the battery case 21 and the retaining element. For example, this can make it possible to use various batteries 11 on the electric bicycle 100 in a simple manner.

The fastening interface 21 comprises two protruding first fastening elements 22, which are arranged on a radially outer edge of the fastening interface 21 (cf. FIG. 4). In particular, the two first fastening elements 22 are arranged on the same side with respect to the circumference of the fastening interface 21.

The two first fastening elements 22 are configured as protruding hooks. Starting from a front side 21b of the fastening interface 21, these hooks protrude in the axial direction as well as additionally in the radial direction.

The end plate 3 also comprises two second fastening elements 32. The second fastening elements 32 are disposed at a radially outer edge of the end plate 3, particularly according to the positions of the first fastening elements 22.

The two second fastening elements 32 are configured as recesses in tabs of the end plate 3.

The end plate 3 can be fastened to the fastening interface 21 by way of the fastening elements 22, 32, in that the second fastening elements 32 are hooked on the first fastening elements 22 in order to thereby produce a positive-locking connection. For this purpose, the fastening elements 22, 32 are configured to permit the hooking by a pivoting movement 36 of the end plate 3 about a pivot axis 35 orthogonal to the longitudinal axis 25.

The hooking is shown in a simplified manner in the schematic diagrams in FIGS. 2 and 3. FIG. 2 shows a state in which the first fastening elements 22 are engaging with the second fastening elements 32, wherein the end plate 3 is arranged at an angle 37 inclined to the fastening interface 21.

Starting from the position shown in FIG. 2, the end plate 3 can be pivoted towards the fastening interface 21 by way of the pivoting movement 36 until the end plate 3 is arranged orthogonal to the longitudinal axis 25.

In this configuration, the end plate 3 is secured to the fastening interface 21, i.e. screwed on, by way of two fixing elements 4, which are configured as screws (cf. FIGS. 3 and 5).

By way of the positive-locking connection, which is generated by way of the fastening elements 22, 32, and additionally by way of securing by way of the fixing elements 4, the end plate 3 is securely fixed to the fastening interface 21 at a total of four positions at least along a direction parallel to the longitudinal axis 25. In this way, a simple and inexpensive design can be used to enable a particularly robust attachment of the end plate 3.

Because the attachment is completed by way of the fastening elements 22, 32, which are integral parts of the end plate 3 and/or fastening interface 21, a particularly space-saving design can also be possible. In particular, a particularly narrow end plate 3 can thus be provided in the direction of the longitudinal axis 25.

As can in particular be seen in FIG. 5, the end plate assembly 1 is symmetrically formed with respect to a longitudinal plane 17 in which the longitudinal axis 25 lies. That is, the fastening elements 22, 32 and the fixing elements 4 are formed and arranged symmetrically to the longitudinal plane 17. In particular, the end plate 3 and the fastening interface 21 are formed symmetrically to the longitudinal plane 17.

What is claimed is:

1. An end plate assembly for a battery of an electric bicycle, comprising:
a battery case with a fastening interface;
an end plate; and
at least one fixing element,
wherein the fastening interface includes at least one protruding first fastening element,
wherein the end plate includes at least one second fastening element configured to be engaged with the first fastening element of the fastening interface to form a positive-locking connection, and
wherein the end plate is configured to be secured to the fastening interface by way of the fixing element.

2. The end plate assembly according to claim 1, wherein the end plate assembly comprises exactly two first fastening elements and exactly two second fastening elements.

3. The end plate assembly according to claim 2, wherein the end plate assembly comprises exactly two fixing elements.

4. The end plate assembly according to claim 1, wherein the battery case extends along a longitudinal axis, and wherein the fastening interface is arranged on a face end of the battery case.

5. The end plate assembly according to claim 4, wherein the end plate is arranged substantially orthogonal to the longitudinal axis when secured.

6. The end plate assembly according to claim 4, wherein the fastening elements are configured so as to permit hooking by pivoting of the end plate about a pivot axis orthogonal to the longitudinal axis.

7. The end plate assembly according to claim 4, wherein the end plate is secured by way of the fixing element.

8. The end plate assembly according to claim 1, wherein the first fastening element is formed as a protruding hook.

9. The end plate assembly according to claim 1, wherein the second fastening element is formed as a recess.

10. The end plate assembly according to claim 1, wherein the fixing element is formed as a screw.

11. The end plate assembly according to claim 1, wherein the first fastening element is disposed at a radially outer edge of the fastening interface.

12. A battery assembly, comprising:
a battery; and
an end plate assembly according to claim 1,
wherein the battery is disposed within the battery case of the end plate assembly.

13. An electric bicycle comprising a battery assembly according to claim 12.

14. The end plate assembly according to claim 4, wherein the battery case extends prismatically along a longitudinal axis.

15. The end plate assembly according to claim 14, wherein the end plate is arranged substantially orthogonal to the longitudinal axis when secured.

16. The end plate assembly according to claim 4, wherein the end plate is secured by way of the fixing element exclusively along a direction parallel to the longitudinal axis.
